(19) United States
(12) Patent Application Publication
(10) Pub. No.: US 2024/0115888 A1
(43) Pub. Date: Apr. 11, 2024

(54) MASK

(71) Applicant: SAMSUNG ELECTRONICS CO., LTD., Suwon-si (KR)

(72) Inventors: Younglae JO, Suwon-si (KR); Joonhyoung KIM, Suwon-si (KR); Hyojin KIM, Suwon-si (KR); Youngchal PARK, Suwon-si (KR); Hyeongjoon SEO, Suwon-si (KR); Youngtae SONG, Suwon-si (KR); Sungjune CHO, Suwon-si (KR); Sungjin CHO, Suwon-si (KR); Wangbyung CHAE, Suwon-si (KR)

(73) Assignee: SAMSUNG ELECTRONICS CO., LTD., Suwon-si (KR)

(21) Appl. No.: 18/216,889

(22) Filed: Jun. 30, 2023

Related U.S. Application Data
(63) Continuation of application No. PCT/KR2023/007826, filed on Jun. 8, 2023.

(30) Foreign Application Priority Data
Oct. 11, 2022 (KR) 10-2022-0129973
Nov. 4, 2022 (KR) 10-2022-0146521

(51) Int. Cl. A62B 18/00; A62B 23/02

(52) U.S. Cl. CPC A62B 18/006; A62B 23/025

(57) ABSTRACT

A mask including a mask body and a blower. The mask body includes a first coupling part, and a second coupling part spaced apart from the first coupling part. The blower includes a third coupling part configured to be detachably couplable to the first coupling part and prevented from being coupled to the second coupling part, and a fourth coupling part configured to be detachably couplable to the second coupling part and prevented from being coupled to the first coupling part. With the third coupling part detachably coupled to the first coupling part and the fourth coupling part detachably coupled to the second coupling part, the blower is disposed to a rear of the mask body and is operable to force air to flow into and out of the mask.

### CROSS-REFERENCE TO RELATED APPLICATIONS

This application is a continuation application of International Application PCT/KR2023/007826, filed Jun. 8, 2023, which is incorporated by reference herein in its entirety, and claims foreign priority to Korean Application 10-2022-0129973, filed Oct. 11, 2022, and Korean Application 10-2022-0146521, filed Nov. 4, 2022, the disclosures of which are incorporated herein by reference in their entireties.

### BACKGROUND

### 1. Field

The disclosure relates to a mask having an improved structure.

### 2. Description of Related Art

A mask is an item that covers the mouth and nose to prevent things like germs or dust from getting in.

In general, the mask may include a filter to protect the respiratory system from particulate harmful substances such as yellow dust and fine dust and various infectious agents. However, the higher the filter rating of the mask, the more difficult it may be for a user to breathe. In addition, if the filter is contaminated, the mask will be less effective, making it difficult to reuse the mask.

Recently, masks that can control airflow inside and be used multiple times are being developed. These masks may include a blower provided to forcibly flow air.

### SUMMARY

According to an embodiment of the disclosure, a mask may include a mask body and a blower. The mask body may include a first coupling part, and a second coupling part spaced apart from the first coupling part, and the blower may include a third coupling part configured to be detachably couplable to the first coupling part and prevented from being coupled to the second coupling part, and a fourth coupling part configured to be detachably couplable to the second coupling part and prevented from being coupled to the first coupling part, so that, with the third coupling part detachably coupled to the first coupling part and the fourth coupling part detachably coupled to the second coupling part, the blower is disposed to a rear of the mask body and is operable to force air to flow into and out of the mask.

According to an embodiment of the disclosure, the first coupling part may include a first magnet, the second coupling part may include a second magnet, the third coupling part may include a third magnet having magnetic attraction with the first magnet and magnetic repulsion with the second magnet, and the fourth coupling part may include a fourth magnet having magnetic attraction with the second magnet and magnetic repulsion with the first magnet.

According to an embodiment of the disclosure, the first coupling part may include a first guide that, with the blower disposed to the rear of the mask body, faces the blower, the third coupling part may include a second guide that, with the blower disposed to the rear of the mask body, faces the first guide part, and the second guide may have a shape corresponding to the first guide to, with blower disposed to the rear of the mask body and the second guide facing the first guide, guide a coupling of the first coupling part and the third coupling part.

According to an embodiment of the disclosure, the second coupling part may include a first guide that, with the blower disposed to the rear of the mask body, faces the blower, the fourth coupling part may include a second guide that, with the blower disposed to the rear of the mask body, faces the first guide, and the second guide may have a shape corresponding to the first guide to, with the blower disposed to the rear of the mask body and the second guide facing the first guide, guide a coupling of the second coupling part and the fourth coupling part.

According to an embodiment of the disclosure, the mask body may be foldable, and the first coupling part and the second coupling part may be couplable in a state in which the mask body is folded.

According to an embodiment of the disclosure, the blower may include a suction module configured to suck air from outside of the mask body, a discharge module configured to discharge air to outside of the mask body, and a connection part configured to connect the suction module and the discharge module and to be foldable, wherein as the connection part is folded, the suction module and the discharge module face each other.

According to an embodiment of the disclosure, the suction module may include the third coupling part, the discharge module may include the fourth coupling part, and the third coupling part and the fourth coupling part may be couplable in a state in which the connection part is folded.

According to an embodiment of the disclosure, the mask may further includes a filter that, with the third coupling part detachably coupled to the first coupling part and the fourth coupling part detachably coupled to the second coupling part so that the blower is disposed to the rear of the mask body, is positionable at a rear of the blower and is configured to cover at least a portion of a user's face.

According to an embodiment of the disclosure, the mask body may further includes a holder configured to hold the filter.

According to an embodiment of the disclosure, the mask body, the blower and the filter may be configured to be foldable together, and the holder may include a first holder part, and a second holder part spaced apart from the first holder part and couplable to the first holder part in a state in which the mask body, the blower, and the filter are folded together.

According to an embodiment of the disclosure, the mask body may be foldable, and the holder may include a first holder part, and a second holder part spaced apart from the first holder part and couplable to the first holder part in a state in which the mask body is folded.

According to an embodiment of the disclosure, the blower may further include a fan configured to generate a blowing force, and a switch configured to operate the fan, and the mask body may further include a button. With the third coupling part detachably coupled to the first coupling part and the fourth coupling part detachably coupled to the second coupling part so that the blower is disposed to the rear of the mask body, the switch may face the mask body, and the button may be positioned to operate the switch.

According to an embodiment of the disclosure, one of the first holder part and the second holder part may include a first magnet, and the other one of the first holder part and the second holder part may include a second magnet that has magnetic attraction with the first magnet.

According to an embodiment of the disclosure, one of the first holder part and the second holder part may include a magnet, and the other one of the first holder part and the second holder part may be configured to be magnetized by the magnet.

According to an embodiment of the disclosure, one of the first holder part and the second holder part may include a coupling protrusion, and the other one of the first holder part and the second holder part may include a coupling groove corresponding to the coupling protrusion.

According to an embodiment of the disclosure, one of the first holder part and the second holder part may include a hook fastener, and the other one of the first holder part and the second holder part may include a loop fastener.

According to an embodiment of the disclosure, a mask may include a mask body; a filter disposed at a rear of the mask body to cover at least a portion of a user's face; a blower disposed between the mask body and the filter to generate airflow, and detachably mounted on the mask body; and a holder provided on a rear side of the mask body to fix the filter to the mask body. The holder may include a first holder part; and a second holder part provided to face the first holder part with respect to a vertical center line of the mask body and couplable to the first holder part.

According to an embodiment of the disclosure, the mask body, the blower and the filter may be provided to be foldable together with respect to the vertical center line. As the first holder part and the second holder part are coupled, the mask body, the blower, and the filter may be provided to maintain a folded state.

According to an embodiment of the disclosure, the mask body may include a first coupling member provided to face the blower. The blower may include a second coupling member provided to be coupled to the first coupling member in a first state and prevented from being coupled to the first coupling member in a second state reversed from the first state.

According to an embodiment of the disclosure, the mask body may be provided to be foldable. The first coupling member may include a first coupling part including a first magnet; and a second coupling part spaced apart from the first coupling part. The second coupling part may include a second magnet in attraction with the first magnet, and may be coupled to the first coupling part in a state in which the mask body is folded.

According to an embodiment of the disclosure, the blower may include a suction module provided to suck air from the outside of the mask body; a discharge module disposed at a side of the suction module and provided to discharge air to the outside of the mask body; and a connection part connecting the suction module and the discharge module and provided to be foldable. The second coupling member may include a third coupling part formed on the suction module. The second coupling member may include a fourth coupling part formed on the discharge module. The third coupling part may include a third magnet in attraction with the first magnet of the first coupling part and in repulsion with the second magnet of the second coupling part. The fourth coupling part may include a fourth magnet in attraction with the second magnet of the second coupling part and in repulsion with the first magnet of the first coupling part. The fourth coupling part may be coupled to the third coupling part in a state in which the connection part is folded.

### BRIEF DESCRIPTION OF THE DRAWINGS

Aspects, features, and advantages of certain embodiments of the present disclosure will be more apparent from the following description taken in conjunction with the accompanying drawings, in which:

FIG. 1 is a perspective view of an example of a mask according to an embodiment of the disclosure.

FIG. 2 is a perspective view of the mask shown in FIG. 1 from a different direction.

FIG. 3 is an exploded view of an example of a mask according to an embodiment of the disclosure.

FIG. 4 is an exploded view of the mask shown in FIG. 3 from a different direction.

FIG. 5 is a rear view of an example of a mask body according to an embodiment of the disclosure.

FIG. 6 is a perspective view of an example of a blower according to an embodiment of the disclosure.

FIG. 7 is a perspective view of the blower shown in FIG. 6 from a different direction.

FIG. 8 is an exploded view of an example of a blower according to an embodiment of the disclosure.

FIG. 9 shows a state in which a blower according to an embodiment of the disclosure is aligned with respect to a mask body in a first state (S1).

FIG. 10 shows a state in which a blower according to an embodiment of the disclosure is aligned with respect to a mask body in a second state (S2).

FIG. 11 shows a state in which a mask body according to an embodiment of the disclosure is being folded.

FIG. 12 shows a state in which a mask body according to an embodiment of the disclosure is folded.

FIG. 13 shows a state in which a blower according to an embodiment of the disclosure is being folded.

FIG. 14 shows a state in which a blower according to an embodiment of the disclosure is folded.

FIG. 15 shows a state in which a mask according to an embodiment of the disclosure is being folded.

FIG. 16 shows a state in which a mask according to an embodiment of the disclosure is folded.

### DETAILED DESCRIPTION

Embodiments described in the disclosure and configurations shown in the drawings are merely examples of the embodiments of the disclosure, and may be modified in various different ways to replace the embodiments and drawings of the disclosure.

The same reference numerals or signs shown in the drawings of the disclosure indicate elements or components performing substantially the same function.

The terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When a part is referred to as being “connected to” another part, it may not only be directly connected to the other part but may in addition be indirectly connected to the other part. Similarly, when a part is referred to as being “coupled to” another part, it may not only be directly coupled to the other part but may in addition be indirectly coupled to the other part.

It will also be understood that when a certain component is referred to as being “on” or “over” another component, it can be directly on the other component or intervening components may also be present.

It will be understood that, although the terms first, second, etc., may be used herein to describe various elements, but elements are not limited by these terms. These terms are only used to distinguish one element from another element. For example, without departing from the scope of the disclosure, a first element may be termed as a second element, and a second element may be termed as a first element.

The term of “and/or” includes a plurality of combinations of relevant items or any one item among a plurality of relevant items.

The terms of “part”, “—module” and “member” may be implemented in hardware or software. In some embodiments, a plurality of “—parts”, “—modules” and “members” may be implemented as a single component. In some embodiments, a single “part”, “—module” and “member” may include multiple components.

The terms “front-rear direction”, “frontward”, “backward”, “lateral direction”, “left-right direction”, “right direction”, “left direction”, “up-down direction”, “upper”, “lower”, etc. are defined based on the drawings, and the shapes and positions of the components are not limited by the terms. For example, an X direction may be defined as a front-rear direction. For example, a Y direction may be defined as a left-right direction (lateral direction). For example, a Z direction may be defined as an up-down direction. For example, a +X direction may be defined as a frontward direction, and a −X direction may be defined as a backward direction. For example, the +Y direction may be defined as a right direction, and the −Y direction may be defined as a left direction. For example, the +Z direction may be defined as an upward direction, and the −Z direction may be defined as a downward direction.

Various embodiments of the disclosure provide a mask with improved usability.

Various embodiments of the disclosure provide a mask with improved assembly performance.

Various embodiments of the disclosure provide a mask capable of preventing improper assembly of the mask.

Various embodiments the disclosure provide a mask that is easy to store.

Aspects, features, objects, advantages of the disclosure are not limited to those described above, and other aspects, features, objects, advantages not described herein will also be clearly understood by a person who has a common knowledge in the technical field to which the disclosure pertains from the following detailed description.

Hereinafter, embodiments according to the disclosure will be described in detail with reference to the accompanying drawings.

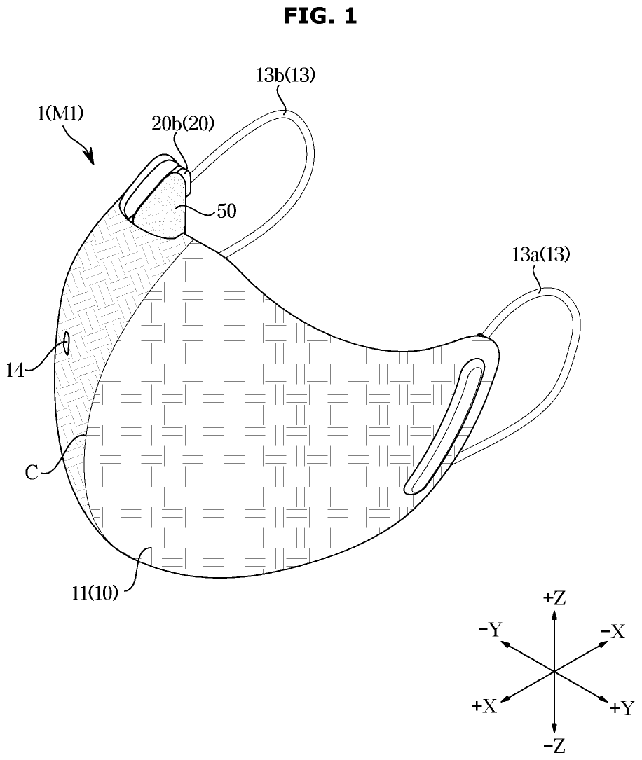

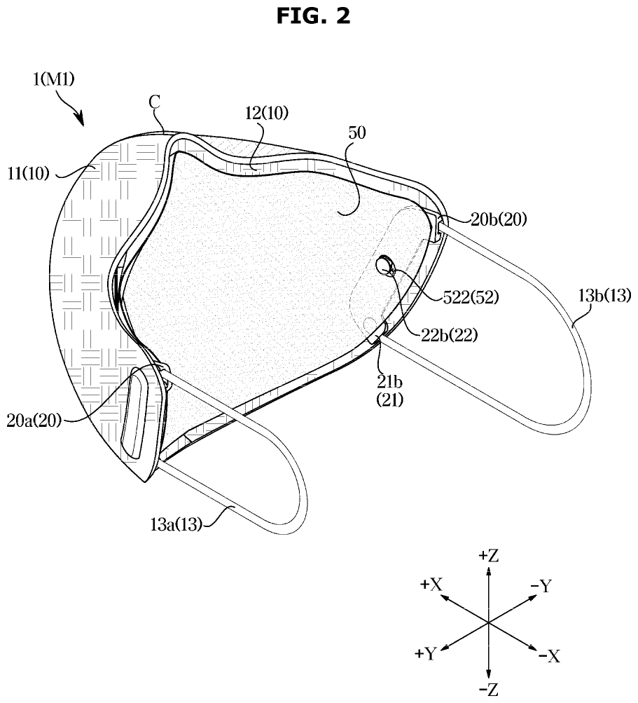

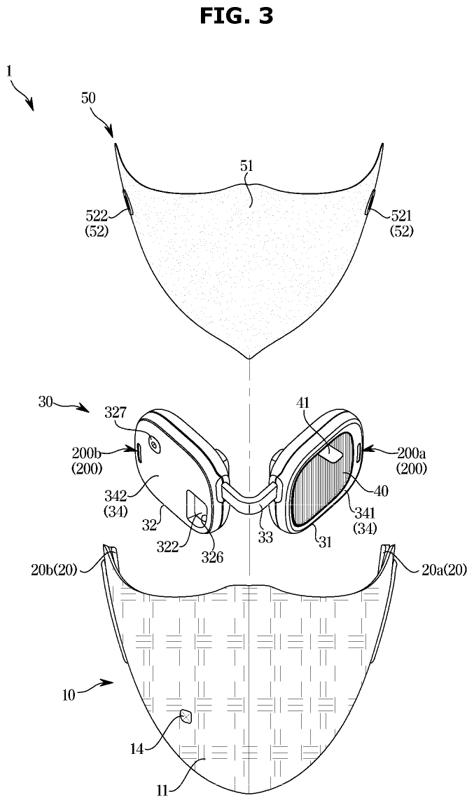

FIG. 1 is a perspective view of an example of a mask according to an embodiment of the disclosure. FIG. 2 is a perspective view of the mask shown in FIG. 1 from a different direction. FIG. 3 is an exploded view of an example of a mask according to an embodiment of the disclosure.

Referring to FIGS. 1 to 4, a mask 1 may include a mask body 10. The mask body 10 may form at least a portion of an exterior of the mask 1. For example, the mask body 10 may form a front appearance of the mask 1.

A front surface 11 of the mask body 10 may be exposed to the outside. The front surface 11 of the mask body 10 may be provided to form a front surface of the mask 1.

A rear surface 12 of the mask body 10 may be positioned opposite the front surface 11 of the mask body 10. The rear surface 12 of the mask body 10 may be provided to face a user's face.

Components of the mask 1 may be detachably mounted on the mask body 10. For example, a blower 30 to be described later may be detachably mounted on the mask body 10. For example, a filter 50 to be described later may be detachably mounted on the mask body 10. More details will be described hereinafter.

The mask body 10 may be provided to allow air to flow in and out. For example, the mask body 10 may be provided so that external air flows. For example, the mask body 10 may be provided so that air passing through at least one filter 40 and/or 50 flows. For example, the mask body 10 may include a fabric material.

In related art, a mask body forming an exterior of a mask may be heavy and rigid by being made of an injection molding material. In comparison, the mask body 10 may be made of a material that allows air to flow in and out and may be lightweight. Accordingly, the portability of the mask body 10 may be improved and storage of the mask body 10 may be facilitated.

The mask body 10 may include a fixing part that may be fixed to at least a portion of a user's body. A user can easily wear the mask through the fixing part.

For example, the fixing part may include an earring portion 13. The earring portion may be provided to be hung on a user's ear. The earring portion 13 may include a left earring portion 13a provided to be hung on a user's left ear. The earring portion 13 may include a right earring portion 13b provided to be hung on a user's right ear.

For example, the earring portion 13 may be detachably mounted on the mask body 10. However, it is not limited thereto, and the earring portion 13 may be integrally formed with the mask body 10.

For example, the earring portion 13 may be detachably coupled to a holder 20 to be described later. For example, the earring portion 13 may be provided to be fixed to the holder 20. For example, the earring portion 13 may be provided as one component of the holder 20. For example, the earring portion 13 may be integrally formed with the holder 20.

The mask body 10 may be referred to as an outer cover.

The mask 1 may include the holder 20. The holder 20 may be provided on a rear side of the mask body 10. The holder 20 may be provided on the rear surface 12 of the mask body 10. The holder 20 may be provided as one component of the mask body 10. That is, the mask body 10 may include the holder 20. For example, the holder 20 may be integrally formed with the mask body 10. However, it is not limited thereto, and the holder 20 may be provided as a separate component separated from the mask body 10. In this case, the holder 20 may be detachably attached to the rear surface 12 of the mask body 10.

The holder 20 may be provided to hold the filter 50. The filter 50 may be detachably mounted on the mask body 10 through the holder 20. The filter 50 may be fixed to the mask body 10 through the holder 20.

For example, the holder 20 may be provided to include at least one holder part 20a, 20b. However, this is merely exemplary, and it is of course possible for the holder 20 to be provided as a single holder part.

For example, the at least one holder part 20a, 20b may include a holder body 21. For example, the at least one holder part 20a, 20b may include a filter coupling portion 22 to which a holder coupling portion 52 of the filter 50 is detachably coupled. For example, the filter coupling portion 22 may extend toward the filter 50 from the holder body 21. For example, the filter coupling portion 22 may protrude backward from the holder body 21. However, it is not limited thereto. The shape of the filter coupling portion 22 is not limited, as long as the filter coupling portion 22 is provided to be coupled to the filter 50.

For example, the holder 20 may include a first holder part 20a and a second holder part 20b. For example, the first holder part 20a may be provided to correspond to a left side portion of the filter 50. For example, the first holder part 20a may be provided to correspond to a first holder coupling portion 521 of the filter 50 to be described later. For example, the second holder part 20b may be provided to correspond to a right side portion of the filter 50. For example, the second holder part 20b may be provided to correspond to a second holder coupling portion 522 of the filter 50 to be described later.

The mask body 10 may include a first coupling member 100 for coupling with the blower 30. The first coupling member 100 may be provided to face the blower 30. The first coupling member 100 may be referred to as a first coupling unit 100. The first coupling member 100 may be referred to as a first coupling module 100. Details of the first coupling member 100 will be described later.

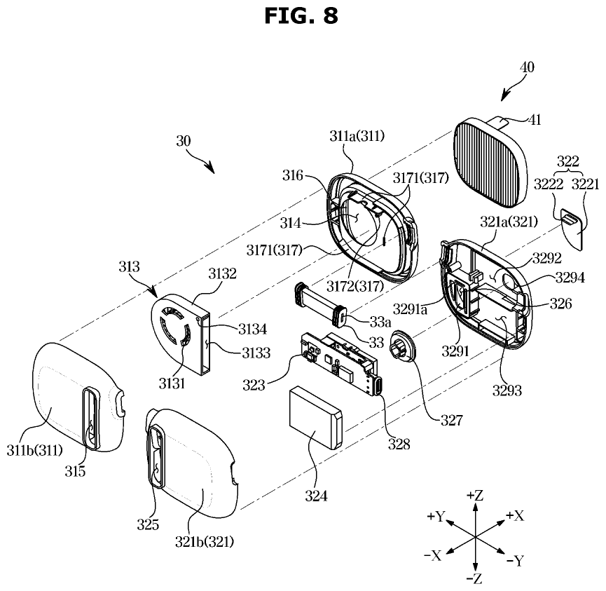

The mask 1 may include the blower 30. The blower 30 may generate a blowing force. The blower 30 may be provided to forcibly flow air. The blower 30 may be provided to generate airflow inside the mask 1. The blower 30 may facilitate the flow of air inside the mask 1. The blower 30 may include a fan 3131 (see FIG. 8) that rotates to generate a blowing force.

For example, the blower 30 may suck external air into the mask 1 during a user's inhalation. For example, the blower 30 may discharge air inside the mask 1 to the outside of the mask 1 during a user's exhalation.

The blower 30 may be disposed at the rear of the mask body 10. The blower 30 may be disposed in front of the filter 50. The blower 30 may be disposed between the mask body 10 and the filter 50. A front surface 34 of the blower 30 may be provided to face the mask body 10. A rear surface 35 of the blower 30 may be provided to face the filter 50.

The blower 30 may be covered by the mask body 10. The blower 30 may not protrude outward from the mask body 10. The blower 30 may be covered by the filter 50. The blower 30 may not protrude outward from the filter 50. The front of the blower 30 may be covered by the mask body 10, and a rear of the blower 30 may be covered by the filter 50. When an assembly of the mask 1 is completed, the blower 30 may be covered by the mask body 10 and the filter 50 and may not be exposed to the outside of the mask 1. For example, as the blower 30 is not exposed to the front of the mask 1, the front surface of the mask 1 (i.e., the front surface 11 of the mask body 10) may maintain a neat appearance. For example, as the blower 30 is not exposed to a rear of the mask 1, the rear surface of the mask 1 (i.e., the rear surface of the filter 50) may maintain a neat appearance. As a result, an aesthetics of the mask 1 can be improved.

The blower 30 may include a first filter 40. The first filter 40 may be provided to filter air introduced from the outside of the mask body 10. The first filter 40 may be provided to filter air that has passed through the mask body 10. The first filter 40 may be provided to filter air drawn into the blower 30 by the fan 3131 (see FIG. 8). The first filter 40 may be disposed between the mask body 10 and the fan 3131 (see FIG. 8).

For example, the first filter 40 may be provided to filter foreign substances such as fine dust, exhaust gas and viruses contained in air. For example, the first filter 40 may be provided to block droplets. For example, the first filter 40 may include a HEPA filter. However, it is not limited thereto, and the first filter 40 may include various filters.

For example, the first filter 40 may include a gripping portion 41 that is grippable by a user. A user can attach the first filter 40 to the blower 30 while holding the gripping portion 41 of the first filter 40. A user can separate the first filter 40 from the blower 30 while holding the gripping portion 41 of the first filter 40. For example, the gripping portion 41 may be made of a flexible material.

The blower 30 may be detachably mounted on the mask body 10. The blower 30 may be detachably coupled to the mask body 10.

The blower 30 may include a second coupling member 200 for coupling with the mask body 10. The second coupling member 200 may be provided to face the mask body 10. The second coupling member 200 may be referred to as a second coupling unit 200. The second coupling member 200 may be referred to as a second coupling module 200. Details of the second coupling member 200 will be described later.

Meanwhile, the ordinal numbers such as “first” and “second” do not limit the configuration. The first coupling member and the second coupling member may be referred as the second coupling member 100 and the first coupling member 200, respectively.

The mask 1 may include a second filter 50. The second filter 50 may be provided to filter at least one of air sucked into the mask 1 or air discharged to the outside of the mask 1.

For example, the second filter 50 may be provided to filter air passing through the mask body 10 and the blower 30 toward a user's face. For example, the second filter 50 may be provided to filter air toward a user's face through only the mask body 10 without passing through the blower 30. For example, the second filter 50 may be provided to filter air exhausted by a user.

The second filter 50 may be provided to allow air to flow in and out in response to a user's breathing. The second filter 50 may be provided to filter air sucked from the outside of the mask body 10 when a user breathes in. The second filter 50 may be provided to filter air discharged toward the outside of the mask body 10 when a user exhales.

For example, the second filter 50 may be provided to filter foreign substances such as fine dust, exhaust gas and viruses contained in air. For example, the second filter 50 may be provided to block droplets. However, it is not limited thereto, and the second filter 50 may include various filters.

The second filter 50 may be disposed at the rear of the mask body 10. The second filter 50 may be disposed at the rear of the blower 30. The second filter 50 may be disposed at the rear of the first filter 40. The second filter 50 may be disposed at the rear of the fan 3131. The second filter 50 may be disposed in front of a user's face. The second filter 50 may be disposed between the blower 30 and a user's face.

The second filter 50 may be provided to cover at least a portion of a user's face. The second filter 50 may be provided adjacent to a user's face. For example, the second filter 50 may be provided to cover a user's nose, cheeks and chin.

The second filter 50 may include a filter body 51. The filter body 51 may form an exterior of the second filter 50. The filter body 51 may be provided to cover a user's face. For example, the filter body 51 may have a size substantially corresponding to that of the mask body 10.

The filter body 51 may be provided to allow air to flow in and out. The filter body 51 may be provided to filter foreign substances contained in air passing through the second filter 50.

The second filter 50 may include the holder coupling portion 52. The holder coupling portion 52 may be detachably coupled to the holder 20. The holder coupling portion 52 may be mounted on the holder 20. The second filter 50 may be fixed to the mask body 10 as the holder coupling portion 52 is coupled to the holder 20.

For example, the holder coupling portion 52 may include the first holder coupling portion 521 and the second holder coupling portion 522.

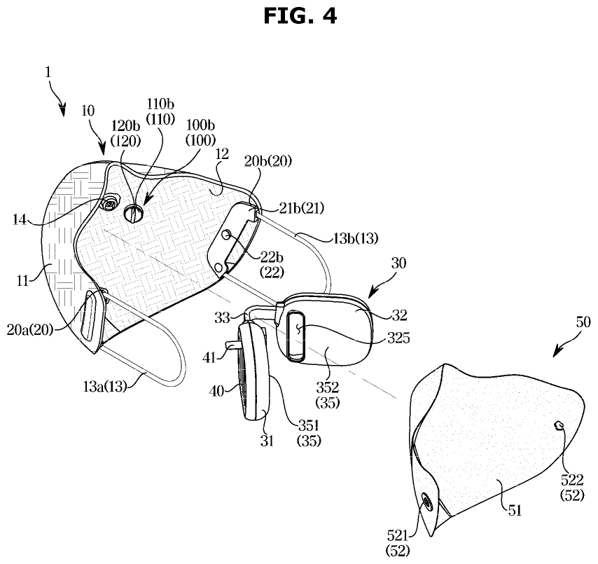

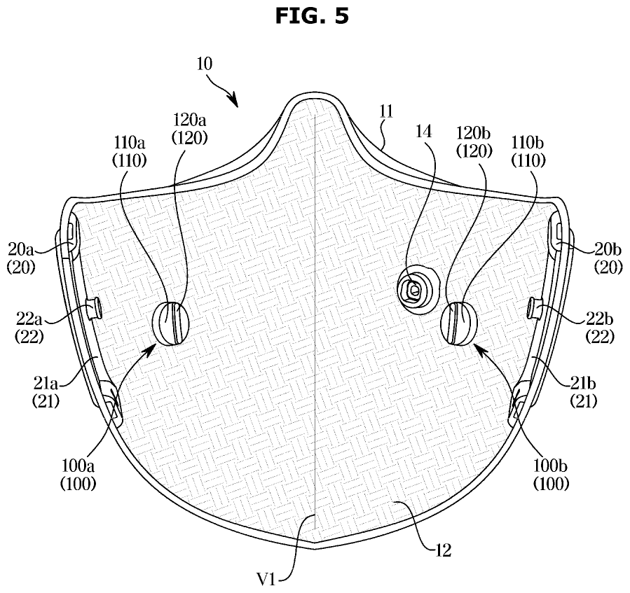

Referring to FIGS. 3 and 4, the first holder coupling portion 521 may be provided to correspond to the first holder part 20a. The first holder coupling portion 521 may be detachably coupled to a first filter coupling portion 22a (see FIG. 5) of the first holder part 20a. The first holder coupling portion 521 may be mounted on the first filter coupling portion 22a of the first holder part 20a. The first holder coupling portion 521 may be formed on the left side portion of the holder body 51.

For example, the first holder coupling portion 521 may include a hole so as to be hung on the first filter coupling portion 22a of the first holder part 20a. For example, the first holder coupling portion 521 may include the hole formed to penetrate the filter body 51. However, it is not limited thereto. The shape of the first holder coupling portion 521 is not limited, as long as the first holder coupling portion 521 is provided to be coupled to the first holder part 20a.

Referring to FIGS. 3 and 4, the second holder coupling portion 522 may be provided to correspond to the second holder part 20b. The second holder coupling portion 522 may be detachably coupled to a second filter coupling portion 22b of the second holder part 20b. The second holder coupling portion 522 may be mounted on the second filter coupling portion 22b of the second holder part 20b. The second holder coupling portion 522 may be formed on the right side portion of the holder body 51.

For example, the second holder coupling portion 522 may include a hole so as to be hung on the second filter coupling portion 22b of the second holder part 20b. For example, the second holder coupling portion 522 may include the hole formed to penetrate the filter body 51. However, it is not limited thereto. The shape of the second holder coupling portion 522 is not limited, as long as the second holder coupling portion 522 is provided to be coupled to the second holder part 20b.

In the drawings, the mask 1 is shown as including a single second filter 50, but the disclosure is not limited thereto. The second filter 50 may be provided in a plurality. For example, the plurality of second filters 50 may be arranged in the front to rear direction.

The second filter 50 may be referred to as an inner cover.

Meanwhile, the ordinal numbers such as “first” and “second” do not limit the configuration. The first filter and the second filter may be referred as the second filter 40 and the first filter 50, respectively.

FIG. 5 is a rear view of an example of a mask body according to an embodiment of the disclosure.

The mask body 10 may include the holder 20 provided to hold the second filter 50.

The holder 20 may include the first holder part 20a. The first holder coupling portion 521 (see FIGS. 3 and 4) of the second filter 50 may be mounted on the first holder part 20a. For example, the first holder part 20a may include a first holder body 21a provided to form an appearance of the first holder part 20a. For example, the first holder part 20a may include the first filter coupling portion 22a to which the first holder coupling portion 521 of the second filter 50 is detachably coupled. For example, the first filter coupling portion 22a may protrude from the first holder body 21a.

The holder 20 may include a second holder part 20b. The second holder part 20b may be spaced apart from the first holder part 20a. The second holder coupling portion 522 (see FIGS. 3 and 4) of the second filter 50 may be mounted on the second holder part 20b. For example, the second holder part 20b may include a second holder body 21b provided to form an appearance of the second holder part 20b. For example, the second holder part 20b may include the second filter coupling portion 22b to which the second holder coupling portion 522 of the second filter 50 is detachably coupled. For example, the second filter coupling portion 22b may protrude from the second holder body 21b.

The first holder part 20a and the second holder part 20b may be provided to face each other with respect to a vertical center line V1 of the mask body 10. For example, the first holder part 20a and the second holder part 20b may be provided to be symmetrical with respect to the vertical center line V1 of the mask body 10. For example, the first holder part 20a and the second holder part 20b may be coupled to each other with respect to the vertical center line V1 of the mask body 10.

The mask body 10 may include the first coupling member 100 to which the blower 30 is detachably coupled. The first coupling member 100 may be provided to face the blower 30. For example, the first coupling member 100 may be formed on the rear surface 12 of the mask body 10.

For example, the first coupling member 100 may include a coupling body 110 for coupling with the second coupling member 200. For example, the first coupling member 100 may include a guide 120 provided to guide coupling with the second coupling member 200. For example, the guide 120 may be formed on the coupling body 110. For example, the guide 120 may protrude from the coupling body 110.

The mask body 10 may include a first coupling part 100a. The first coupling part 100a may be provided as one component of the first coupling member 100. A third coupling part 200a of the blower 30 to be described below may be detachably coupled to the first coupling part 100a of the mask body 10.

For example, the first coupling part 100a may include a first coupling body 110a for coupling with the third coupling part 200a. For example, the first coupling part 100a may include a first guide 120a to guide coupling with the third coupling part 200a. For example, the first guide 120a may be formed on the first coupling body 110a. For example, the first guide 120a may protrude from the first coupling body 110a.

The mask body 10 may include a second coupling part 100b. The second coupling part 100b may be spaced apart from the first coupling part 100a. The second coupling part 100b may be provided as one component of the first coupling member 100. A fourth coupling part 200b of the blower 30 to be described below may be detachably coupled to the second coupling part 100b of the mask body 10.

For example, the second coupling part 100b may include a second coupling body 110b for coupling with the fourth coupling part 200b. For example, the second coupling part 100b may include a second guide 120b to guide coupling with the fourth coupling part 200b. For example, the second guide 120b may be formed on the second coupling body 110b. For example, the second guide 120b may protrude from the second coupling body 110b.

The first coupling part 100a and the second coupling part 100b may be provided to face each other with respect to the vertical center line V1 of the mask body 10. For example, the first coupling part 100a and the second coupling part 100b may be provided to be symmetrical with respect to the vertical center line V1 of the mask body 10.

The mask body 10 may include a button 14. In a state in which the first coupling part 100a and the third coupling part 200a are coupled and the second coupling part 100b and the fourth coupling part 200b are coupled, the button 14 may be positioned to correspond to an input unit 327 of the blower 30. In a state where the button 14 and the input unit 327 correspond, the button 14 may transmit an input signal to the input unit 327. In a state in which the button 14 and the input unit 327 correspond, the button 14 may be provided to be in contact with the input unit 327 of the blower 30. A user can easily operate the blower 30 disposed behind the mask body 10 through the button 14.

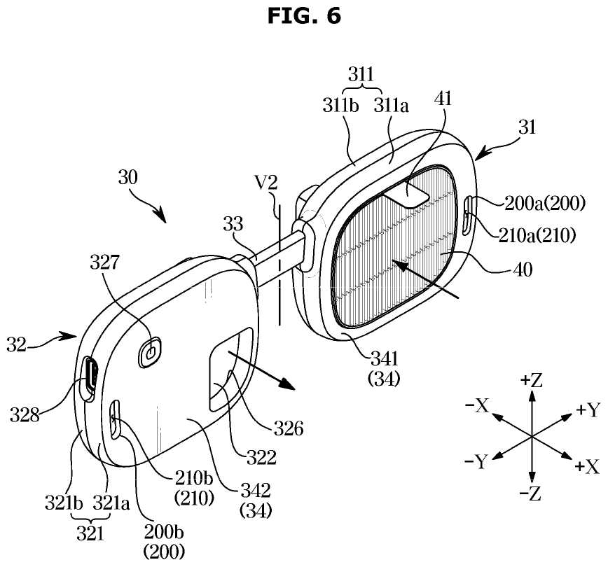

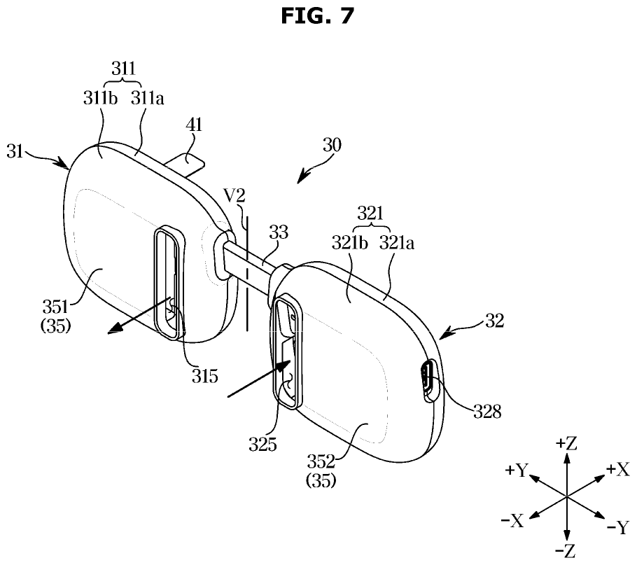

FIG. 6 is a perspective view of an example of a blower according to an embodiment of the disclosure. FIG. 7 is a perspective view of the blower shown in FIG. 6 from a different direction. FIG. 8 is an exploded view of an example of a blower according to an embodiment of the disclosure.

The blower 30 may include one or more blowing modules. For example, the blower 30 may include a first blowing module 31 and a second blowing module 32.

Any one of the first blowing module 31 and the second blowing module 32 may be provided to suck in external air. The other one of the first blowing module 31 and the second blowing module 32 may be provided to discharge air inside the mask 1 to the outside. The first blowing module 31 and the second blowing module 32 may be disposed laterally. The first blowing module 31 and the second blowing module 32 may be disposed in the left and right direction. The first blowing module 31 may be disposed between the mask body 10 and the second filter 50. The second blowing module 32 may be disposed between the mask body 10 and the second filter 50.

For example, the first blowing module 31 may be provided to draw in external air. The first blowing module 31 may suck air from the outside of the mask body 10 and discharge it toward a user's face. Air discharged from the first blowing module 31 may pass through the second filter 50 and flow toward a user's face. The first blowing module 31 may be referred to as a suction module 31.

For example, the second blowing module 32 may be provided to discharge air inside the mask 1 to the outside of the mask 1. The second blowing module 32 may discharge air between the second filter 50 and a user's face toward the mask body 10. Air discharged from the second blowing module 32 may pass through the mask body 10 and flow out of the mask 1. The second blowing module 32 may be referred to as a discharge module 32.

The blower 30 may include a connection part 33. The connection part 33 may be provided between the first blowing module 31 and the second blowing module 32. The connection part 33 may be provided to connect the first blowing module 31 and the second blowing module 32.

The connection part 33 may be provided to guide components of the first blowing module 31 to the second blowing module 32. The connection part 33 may be provided to guide components of the second blowing module 32 to the first blowing module 31. For example, the connection part 33 may be provided to cover a wire (not shown) of the first blowing module 31 and/or a wire (not shown) of the second blowing module 32. For example, the wire (not shown) of the first blowing module 31 may pass through a guide passage 33a of the connection part 33 and enter the second blowing module 32. For example, a wire (not shown) of a fan unit 313 (see FIG. 8) may pass through the guide passage 33a of the connection part 33 and enter the second blowing module 32.

The connection part 33 may be provided to be flexible. The connection part 33 may be provided to be foldable. For example, the connection part 33 may include at least one of rubber or silicon. However, this is merely exemplary, and the connection part 33 may include various materials.

The first blowing module 31 may include a first case 311 forming an appearance of the first blowing module 31. The first case 311 may be provided to accommodate components of the first blowing module 31.

For example, the first case 311 may include a first front case 311a provided to face the mask body 10. For example, the first case 311 may include a first rear case 311b provided to face a user's face. The first front case 311a and the first rear case 311b may be detachably coupled.

The first case 311 may include a filter mounting portion 316 to which the first filter 40 is detachably mounted. For example, the filter mounting portion 316 may be formed on the front case 311a. For example, the filter mounting portion 316 may be formed adjacent to a first opening 314.

The first case 311 may include a fan unit mounting portion 317 to which the fan unit 313 is detachably mounted. For example, the fan unit mounting portion 317 may be formed inside the first case 311.

The first blowing module 31 may include the first opening 314 through which air flows into the first blowing module 31. External air may flow into the first blowing module 31 through the first opening 314. Air passing through the mask body 10 may flow toward the fan unit 313 through the first opening 314. The first opening 314 may be provided to correspond to the first filter 40. The first opening 314 may be formed in the first case 311. For example, the first opening 314 may be formed in the first front case 311a.

The first blowing module 31 may include a second opening 315 through which air flows out of the first blowing module 31. Air passing through the first blowing module 31 may flow out of the blower 30 through the second opening 315. Air that has passed through the first filter 40 and the fan 3131 may flow out of the blower 30 through the second opening 315. Air discharged through the second opening 315 may flow toward the second filter 50. Air discharged through the second opening 315 may flow backward. For example, the second opening 315 may be formed in the first rear case 311b. For example, the second opening 315 may be formed on a rear surface 351 of the first blowing module 31.

The first blowing module 31 may include a first filter 40. The first filter 40 may be detachably mounted on the filter mounting portion 316. The first filter 40 may be disposed to correspond to the first opening 314. Air passing through the first filter 40 may flow into the first blowing module 31 through the first opening 314.

The first blowing module 31 may include the fan unit 313. The fan unit 313 may generate a blowing force to draw in outside air. The fan unit 313 may form airflow inside the mask 1. The fan unit 313 may be covered by the mask body 10 and the second filter 50.

For example, the fan unit 313 may include the fan 3131 generating blowing force. For example, the fan unit 313 may include a fan case 3132 for accommodating the fan 3131. For example, the fan unit 313 may include a fan driving unit (not shown) provided to drive the fan 3131.

The fan unit 313 may include a communicating portion 3133. The communicating portion 3133 may be formed in the fan case 3132. The communicating portion 3133 may be disposed to correspond to a discharge side of the fan 3131. The communicating portion 3133 may be provided to communicate with the second opening 315. Air discharged from the communicating portion 3133 may flow out of the blower 30 through the second opening 315.

The fan unit 313 may be disposed inside the first blowing module 31. The fan unit 313 may be accommodated in the first case 311. The fan unit 313 may be detachably mounted on the fan unit mounting portion 317.

For example, the fan unit mounting portion 317 may include a fixing rib 3171 provided to fix the fan unit 313. The fixing rib 3171 may protrude toward the fan unit 313. The fixing rib 3171 may be provided to fix the outside of the fan case 3132.

For example, the fan unit mounting portion 317 may include a fixing protrusion 3172 provided to fix the fan unit 313. The fixing protrusion 3172 may protrude toward the fan unit 313. For example, a fixing hole 3134 formed in the fan case 3132 may be detachably coupled to the fixing protrusion 3172. The fixing hole 3134 of the fan unit 313 may be inserted into the fixing protrusion 3172 of the fan unit mounting portion 317. However, unlike what is shown in the drawing, the fan case 3132 may include a fixing protrusion, and the fan unit mounting portion 317 may include a fixing hole.

The fan unit 313 may be electrically connected to a controller 323 of the blower 30 to be described later. For example, the fan unit 313 may include a wire (not shown) connected to the controller 323. For example, the wire (not shown) of the fan unit 313 may pass through the connection part 33 and be connected to the controller 323. For example, a wire (not shown) of the fan driving unit may pass through the connection part 33 and be connected to the controller 323. Thus, the fan 3131 may be provided to operate in response to an output signal of the controller 323.

The fan unit 313 may be referred to as a fan assembly.

The second blowing module 32 may include a second case 321 forming an appearance of the second blowing module 32. The second case 321 may be provided to accommodate components of the second blowing module 32.

For example, the second case 321 may include a second front case 321a provided to face the mask body 10. For example, the second case 321 may include a second rear case 321b provided to face a user's face. The second front case 321a and the second rear case 321b may be detachably coupled.

The second case 321 may include an exhaust valve mounting portion 3291 to which an exhaust valve 322 to be described later may be detachably mounted. For example, the exhaust valve mounting portion 3291 may include a hinge coupling portion 3291a to which a hinge 3222 of the exhaust valve 322 is detachably coupled. For example, the exhaust valve mounting portion 3291 may be formed on the second front case 321a. However, it is not limited thereto, and the exhaust valve mounting portion 3291 may be formed in various positions for mounting the exhaust valve 322.

The second case 321 may include a controller mounting portion 3292 to which the controller 323 may be detachably mounted. For example, the controller mounting portion 3292 may be formed on the second front case 321a. However, it is not limited thereto, and the controller mounting portion 3292 may be formed in various positions for mounting the controller 323.

The second case 321 may include a battery mounting portion 3293 in which a battery 324 may be detachably mounted. For example, the battery mounting portion 3293 may be formed on the second front case 321a. However, it is not limited thereto, and the battery mounting portion 3293 may be formed in various positions for mounting the battery 324.

The second case 321 may include an input unit mounting portion 3294 to which the input unit 327 to be described later may be detachably mounted. For example, the input unit mounting portion 3294 may be formed on the second front case 321a. However, it is not limited thereto, and the input unit mounting portion 3294 may be formed in various positions for mounting the input unit 327.

The second blowing module 32 may include a third opening 325 through which air flows into the second blowing module 32. Air between the second filter 50 and a user's face may pass through the second filter 50 and be introduced into the second blowing module 32 through the third opening 325. Air exhausted from a user may pass through the second filter 50 and be introduced into the second blowing module 32 through the third opening 325. The third opening 325 may be formed in the second case 321. For example, the third opening 325 may be formed in the second rear case 321b. For example, the third opening 325 may be formed on a rear surface 352 of the second blowing module 32.

The second blowing module 32 may include a fourth opening 326 through which air flows out of the second blowing module 32. Air passing through the second blowing module 32 may flow toward the mask body 10 through the fourth opening 326. Air flowing out through the fourth opening 326 may pass through the mask body 10 and be discharged to the outside of the mask 1. Air discharged through the fourth opening 326 may flow forward. The fourth opening 326 may be formed in the second case 321. For example, the fourth opening 326 may be formed in the second front case 321a.

The second blowing module 32 may include the exhaust valve 322. The exhaust valve 322 may be provided to open and close the fourth opening 326. For example, the exhaust valve 322 may be provided to open the fourth opening 326 when a user exhales. For example, the exhaust valve 322 may be provided to close the fourth opening 326 when a user breathes in. Thereby, the exhaust valve 322 may be provided to prevent backflow of air discharged to the outside of the mask 1. The exhaust valve 322 may only allow air to flow in a discharge direction. For example, the exhaust valve 322 may prevent air discharged by a user from flowing back toward the user. For example, exhaust valve 322 may only allow forward flow of air. For example, the exhaust valve 322 may be provided as a check valve.

For example, the exhaust valve 322 may include an opening and closing plate 3221. For example, the exhaust valve 322 may include the hinge 3222.

The hinge 3222 may be detachably coupled to the hinge coupling portion 3291a. The opening and closing plate 3221 may be provided to open and close the fourth opening 326 as the hinge 3222 rotates. In a state in which the hinge 3222 is coupled to the hinge coupling portion 3291a, the opening and closing plate 3221 may be provided to rotate upward. For example, the hinge 3222 may be provided on an upper side of the opening and closing plate 3221.

The blower 30 may include the controller 323. The controller 323 may be provided to control the operation of the mask 1. The controller 323 may be provided to control the operation of the blower 30. For example, the controller 323 may be provided to control the operation of the fan unit 313. For example, the controller 323 may be provided to control the operation of the fan 3131. For example, the controller 323 may be provided to control on/off of the fan 3131. For example, the controller 323 may be provided to control the rotational speed of the fan 3131. For example, the controller 323 may be provided as a printed board assembly (PBA).

For example, the controller 323 may be accommodated in the second case 321. For example, the controller 323 may be detachably mounted on the controller mounting portion 3292. However, it is not limited thereto, and the controller 323 may be accommodated in the first case 321.

The blower 30 may include the battery 324. The battery 324 may be provided to supply power to the mask 1. The battery 324 may be provided to supply power to components of the mask 1. For example, the battery 324 may be provided to supply power to the blower 30.

For example, the battery 324 may be accommodated in the second case 321. For example, the battery 324 may be detachably mounted on the battery mounting unit 3293. However, it is not limited thereto, and the battery 324 may be accommodated in the first case 321.

The blower 30 may include a charging terminal 328. The charging terminal 328 may receive power from the outside. The charging terminal 328 may be provided to charge the battery 324. The charging terminal 328 may be electrically connected to the controller 323.

For example, the charging terminal 328 may be accommodated in the second case 321. For example, the charging terminal 328 may be detachably mounted on the battery mounting portion 3293. However, it is not limited thereto, and the charging terminal 328 may be accommodated in the first case 321.

The blower 30 may include the input unit 327 for operating the fan 3131. The input unit 327 may be provided to receive a user's command. The input unit 327 may be provided to be electrically connected to the controller 323. The input unit 327 may transmit information received from the user to the controller 323. The controller 323 may control the blower 30 based on information transmitted from the input unit 327. The input unit 327 may be referred to as a switch 327.

In a state where the mask body 10 and the blower 30 are coupled, the input unit 327 may be disposed at a position corresponding to the button 14. For example, in a state in which the first coupling part 100a and the third coupling part 200a are coupled and the second coupling part 100b and the fourth coupling part 200b are coupled, the input unit 327 may correspond to the button 14. For example, when the mask body 10 and the blower 30 are coupled, a user may operate an input unit 327 of the blower 30 by touching or pressing the button 14 of the mask body 10. For example, the input unit 327 may protrude from a front surface 342 of the second blowing module 32 within a predetermined range to be in contact with the button 14.

For example, the input unit 327 may be detachably mounted on the second case 321. For example, the input unit 327 may be detachably mounted on the input unit mounting portion 3294.

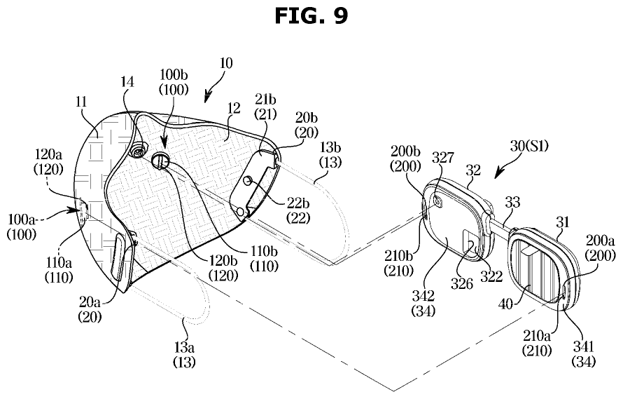

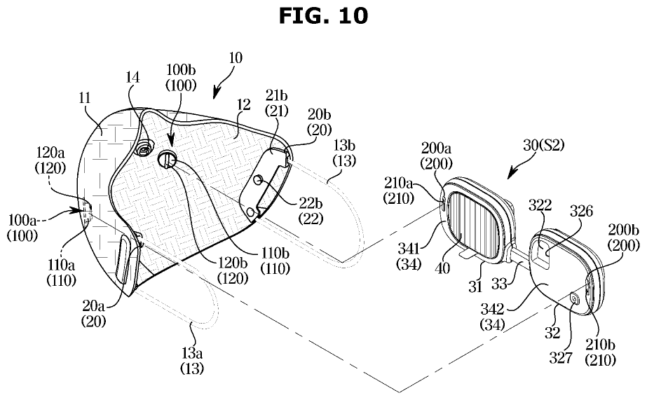

FIG. 9 shows a state in which a blower according to an embodiment of the disclosure is aligned with respect to a mask body in a first state (S1). FIG. 10 shows a state in which a blower according to an embodiment of the disclosure is aligned with respect to a mask body in a second state (S2).

Referring to FIGS. 9 and 10, the mask body 10 may include a first coupling member 100 provided to face the blower 30. For example, the first coupling member 100 may be provided on the rear surface 12 of the mask body 10. The blower 30 may include a second coupling member 200 provided to face the mask body 30. For example, the second coupling member 200 may be provided on the front surface 34 of the blower 30. For coupling of the mask body 10 and the blower 30, the front surface 34 of the blower 30 may face the rear surface 12 of the mask body 10.

The first coupling member 100 may include a first coupling part 100a and a second coupling part 100b. The second coupling part 100b may be spaced apart from the first coupling part 100a.

For example, the first coupling part 100a may include a first magnet. For example, the second coupling part 100b may include a second magnet. For example, an attractive force may act between the first magnet of the first coupling part 100a and the second magnet of the second coupling part 100b.

The second coupling member 200 may include a third coupling part 200a and a fourth coupling part 200b. The fourth coupling part 200b may be spaced apart from the third coupling part 200a.

For example, the third coupling part 200a may be formed in the first blowing module 31. For example, the first blowing module 31 may include the third coupling part 200a. For example, the third coupling part 200a may be provided on a front surface 341 of the first blowing module 31. For example, the fourth coupling part 200b may be formed on the second blowing module 32. For example, the second blowing module 32 may include the fourth coupling part 200b. For example, the fourth coupling part 200b may be provided on the front surface 342 of the second blowing module 32.

For example, the third coupling part 200a may include a third magnet in attraction with the first magnet of the first coupling part 100a and in repulsion with the second magnet of the second coupling part 100b. For example, the fourth coupling part 200b may include a fourth magnet in attraction with the second magnet of the second coupling part 100b and in repulsion with the first magnet of the first coupling part 100a.

For example, the first coupling part 100a and the fourth coupling part 200b may include N-pole, and the second coupling part 100b and the third coupling part 200a may include 5-pole. For example, the first coupling part 100a and the fourth coupling part 200b may include 5-pole, and the second coupling part 100b and the third coupling part 200a may include N-pole.

Referring to FIG. 9, when the blower 30 is aligned with the mask body 10 in the first state S1, the second coupling member 200 may be couplable to the first coupling member 100. The first state S1 of the blower 30 may refer to a state in which the blower 30 is ready to be assembled into a proper position on the mask body 10.

When the blower 30 is aligned with the mask body 10 in the first state S1, the third coupling part 200a of the blower 30 may correspond to the first coupling part 100a of the mask body 10. The third coupling part 200a may be detachably coupled to the first coupling part 100a.

For example, an attractive force may act between the first coupling part 100a and the third coupling part 200a. Thus, the first coupling part 100a and the third coupling part 200a can be easily coupled. A user can easily assemble the mask body 10 and the blower 30 without exerting much force.

The first coupling part 100a may include a first guide 120a. The first guide 120a may be provided to face the blower 30. The third coupling part 200a may include a third guide 210a. The third guide 210a may be provided to face the mask body 10.

The third guide 210a may be provided to guide the coupling of the first coupling part 100a and the third coupling part 200a while facing the first guide 120a. The third guide 210a may have a shape corresponding to first guide 120a. In a state where the first coupling part 100a and the third coupling part 200a face each other, the first guide 120a and the third guide 210a having corresponding shapes may be first engaged. Thereby, the first coupling part 100a and the third coupling part 200a can be easily coupled. As the first guide 120a and the third guide 210a are engaged, the coupling force between the first coupling part 100a and the third coupling part 200a may increase.

For example, the first guide 120a is provided as a protrusion protruding backward from the rear surface 12 of the mask body 10. The third guide 210a may be provided as a groove that is recessed backward from the front surface 341 of the first blowing module 31. However, it is not limited thereto, and the first guide 120a may be provided as a groove and the third guide 210a may be provided as a protrusion.

When the blower 30 is aligned with the mask body 10 in the first state S1, the fourth coupling part 200b of the blower 30 may correspond to the second coupling part 100b of the mask body 10. The fourth coupling part 200b may be detachably coupled to the second coupling part 100b.

For example, an attractive force may act between the second coupling part 100b and the fourth coupling part 200b. Thus, the second coupling part 100b and the fourth coupling part 200b can be easily coupled. A user can easily assemble the mask body 10 and the blower 30 without exerting much force.

The second coupling part 100b may include a second guide 120b. The second guide 120b may be provided to face the blower 30. The fourth coupling part 200b may include a fourth guide 210b. The fourth guide 210b may be provided to face the mask body 10.

The fourth guide 210b may be provided to guide the coupling of the second coupling part 100b and the fourth coupling part 200b while facing the second guide 120b. The fourth guide 210b may have a shape corresponding to the second guide 120b. In a state where the second coupling part 100b and the fourth coupling part 200b face each other, the second guide 120b and the fourth guide 210b having corresponding shapes may be first engaged. Thereby, the second coupling part 100b and the fourth coupling part 200b can be easily coupled. As the second guide 120b and the fourth guide 210b are engaged, the coupling force between the second coupling part 100b and the fourth coupling part 200b may increase.

For example, the second guide 120b is provided as a protrusion protruding backward from the rear surface 12 of the mask body 11. The fourth guide 210b may be provided as a groove that is recessed backward from the front surface 341 of the first blowing module 31. However, it is not limited thereto, and the second guide 120b may be provided as a groove and the fourth guide 210b may be provided as a protrusion.

As the first coupling part 100a and the third coupling part 200a are easily coupled and the second coupling part 100b and the fourth coupling part 200b are easily coupled, the mask body 10 and the blower 30 may be easily assembled. In addition, the mask body 10 and the blower 30 may be coupled to each other in an accurate position. As a result, the assemblability of the mask 1 may be improved.

When the blower 30 is aligned with the mask body 10 in the first state S1, the input unit 327 of the blower 30 may correspond to the button 14 of the mask body 10. The input unit 327 may be provided to be in contact with the button 14. A user may touch or press the button 14, and the input unit 327 may be provided to receive a user command through the button 14.

Referring to FIG. 10, when the blower 30 is aligned with the mask body 10 in the second state S2, the second coupling member 200 may be prevented from coupling to the first coupling member 100. The second state S2 of the blower 30 may refer to a state in which the blower 30 is provided in a position that allows it to be misassembled to the mask body 10. For example, the second state S2 of the blower 30 may mean a state in which the blower 30 is inverted from the first state S1. For example, the second state S2 of the blower 30 may mean a state in which the blower 30 is rotated approximately 180 degrees from the first state S2. For example, the second state S2 of the blower 30 may mean a state in which the positions of the first blowing module 31 and the second blowing module 32 are reversed.

When the blower 30 is aligned with the mask body 10 in the second state S2, the third coupling part 200a of the blower 30 may correspond to the second coupling part 100b of the mask body 10. The third coupling part 200a may be prevented from being coupled to the second coupling part 100b.

For example, as a repulsive force acts between the second coupling part 100b and the third coupling part 200a, the second coupling part 100b and the third coupling part 200a may not be coupled. Thus, the blower 30 cannot be assembled to the mask body 10 when it is provided in the second state S2. As a repulsive force acts between the second coupling part 100b and the third coupling part 200a, a user may easily recognize that the blower 30 is not properly aligned with the mask body 10. As a result, mis-assembly of the mask body 10 and the blower 30 may be prevented.

When the blower 30 is aligned with the mask body 10 in the second state S2, the fourth coupling part 200b of the blower 30 may correspond to the first coupling part 100a of the mask body 10. The fourth coupling part 200b may be prevented from being coupled to the first coupling part 100a.

For example, as a repulsive force acts between the first coupling part 100a and the fourth coupling part 200b, the first coupling part 100a and the fourth coupling part 200b may not be coupled. Thus, the blower 30 cannot be assembled to the mask body 10 when it is provided in the second state S2. As a repulsive force acts between the first coupling part 100a and the fourth coupling part 200b, a user may easily determine that the blower 30 is not properly aligned with the mask body 10. As a result, erroneous assembly of the mask body 10 and the blower 30 can be prevented.

When the blower 30 is aligned with the mask body 10 in the second state S2, the input unit 327 of the blower 30 may not correspond to the button 14 of the mask body 10. Accordingly, even when a user touches or presses the button 14, the input unit 327 may not receive a user command through the button 14. As described above, when the blower 30 is aligned in the second state S2 with respect to the mask body 10, the first coupling member 100 and the second coupling member 200 may not be coupled. As described above, when the blower 30 is aligned in the second state S2 with respect to the mask body 10, the second coupling part 100b and the third coupling part 200a may not be coupled. As described above, when the blower 30 is aligned in the second state S2 with respect to the mask body 10, the first coupling part 100a and the fourth coupling part 200b may not be coupled. As erroneous assembly of the blower 30 and the mask body 10 is prevented, assembly of the input unit 327 and the button 14 in a non-corresponding state may also be prevented. A user can easily recognize whether the input unit 327 and the button 14 correspond according to whether the first coupling member 100 and the second coupling member 200 are coupled. That is, when the first coupling member 100 and the second coupling member 200 are coupled, a user can easily recognize that the input unit 327 and the button 14 are positioned to correspond to each other. Conversely, when the first coupling member 100 and the second coupling member 200 are not coupled, a user can easily recognize that the input unit 327 and the button 14 are not positioned to correspond to each other.

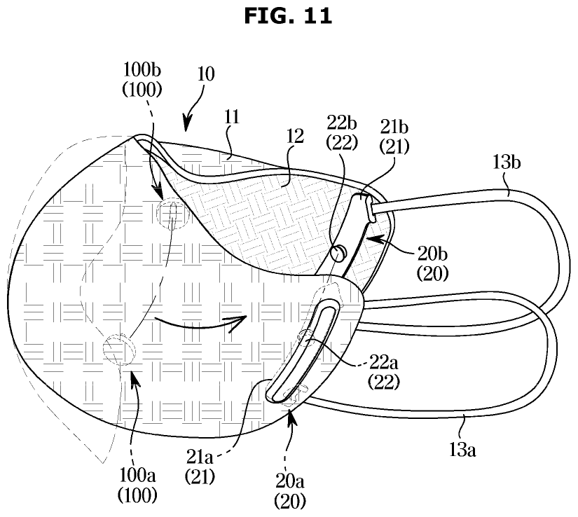

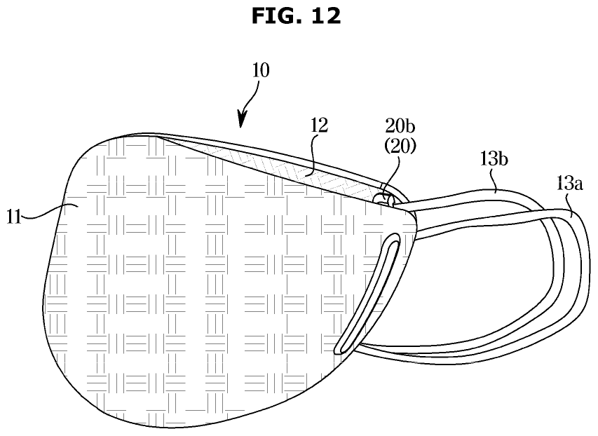

FIG. 11 shows a state in which a mask body according to an embodiment of the disclosure is being folded. FIG. 12 shows a state in which a mask body according to an embodiment of the disclosure is folded.

Referring to FIGS. 11 and 12, the mask body 10 may be provided to be flexible. The mask body 10 may be provided to be foldable.

For example, the mask body 10 may be provided to be foldable with respect to a vertical center line (V1, see FIG. 5) of the mask body 10. For example, the mask body 10 may be folded in half. For example, as the mask body 10 is folded in half, a left portion of the mask body 10 and a right portion of the mask body 10 may be provided to face each other. For example, as the mask body 10 is folded in half, the left portion of the mask body 10 and the right portion of the mask body 10 may overlap each other.

As the mask body 10 is folded, the first coupling part 100a and the second coupling part 100b may face each other. As the mask body 10 is folded, the first coupling part 100a and the second coupling part 100b may be provided to correspond to each other.

When the mask body 10 is in a folded state, the first coupling part 100a and the second coupling part 100b may be coupled to each other.

For example, the first coupling part 100a may include the first magnet, and the second coupling part 100b may include the second magnet that is attracted to the first magnet. As an attractive force acts between the first coupling part 100a and the second coupling part 100b, a user may easily couple the first coupling part 100a and the second coupling part 100b without exerting great force.

As the mask body 10 is folded, the first holder part 20a and the second holder part 20b may face each other. As the mask body 10 is folded, the first holder part 20a and the second holder part 20b may be provided to correspond to each other.

When the mask body 10 is in a folded state, the first holder part 20a and the second holder part 20b may be coupled to each other.

For example, one of the first holder part 20a and the second holder part 20b includes a fifth magnet, and the other one of the first holder part 20a and the second holder part 20b includes a sixth magnet in attraction with the fifth magnet. For example, the fifth magnet may be N-pole and the sixth magnet may be S-pole. For example, the fifth magnet may be S-pole and the sixth magnet may be N-pole.

For example, one of the first holder part 20a and the second holder part 20b includes the fifth magnet, and the other one of the first holder part 20a and the second holder part 20b may be magnetized by the fifth magnet. For example, one of the first holder part 20a and the second holder part 20b includes the sixth magnet, and the other one of the first holder part 20a and the second holder part 20b includes may be magnetized by the sixth magnet.

For example, one of the first holder part 20a and the second holder part 20b may include a coupling protrusion, and the other of the first holder part 20a and the second holder part 20b may include a coupling groove corresponding to the coupling protrusion. For example, the first holder part 20a may include a coupling protrusion, and the second holder part 20b may include a coupling groove detachably coupled to the coupling protrusion. For example, the first holder part 20a may include a coupling groove, and the second holder part 20b may include a coupling protrusion detachably coupled to the coupling groove.

For example, the first holder part 20a and the second holder part 20b may be provided to be attached using a velcro method. For example, one of the first holder part 20a and the second holder part 20b may include a hook fastener, and the other of the first holder part 20a and the second holder part 20b may include a hook fastener. For example, the first holder part 20a may include a hook fastener, and the second holder part 20b may include a loop fastener. For example, the first holder part 20a may include a loop fastener, and the second holder part 20b may include a hook fastener.

However, it is not limited to the above examples, and the first holder part 20a and the second holder part 20b may be coupled by various known methods.

When the mask body 10 is folded, the first coupling part 100a and the second coupling part 100b may be coupled, or the first holder part 20a and the second holder part 20b may be coupled. When the mask body 10 is folded, the first coupling part 100a and the second coupling part 100b may be coupled, and the first holder part 20a and the second holder part 20b may be coupled.

The mask body 10 may maintain the folded state as the first coupling part 100a and the second coupling part 100b are coupled. The mask body 10 may maintain the folded state as the first holder part 20a and the second holder part 20b are coupled.

The mask body 10 may be stored in the folded state. The mask body 10 may be stored separately from the blower 30. The mask body 10 may be stored separately from the second filter 50. Thus, storage of the mask body 10 may be facilitated.

For example, referring to FIG. 12, the mask body 10 may be stored in the folded state, whereby the space occupied by the mask body 10 may be reduced. Portability of the mask body 10 may be improved in the folded state. An inner portion of the mask body 10 may not be easily contaminated in the folded state. For example, with the mask body 10 folded, the rear surface 12 of the mask body 10 may not be exposed to external debris or the like.

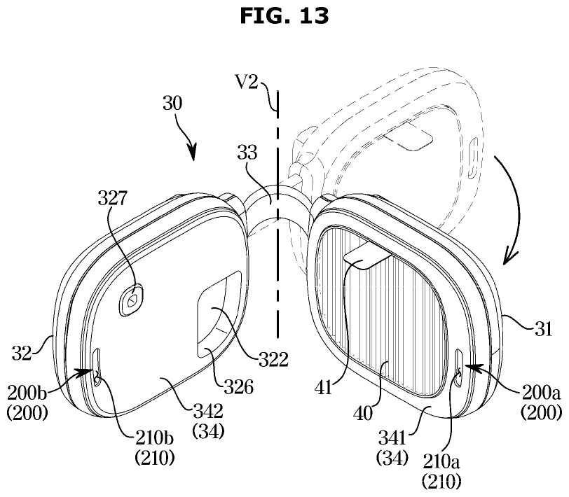

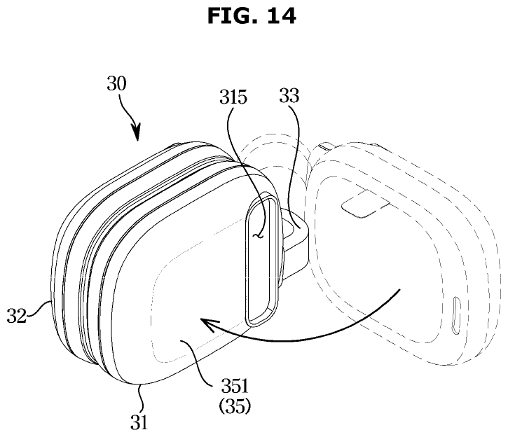

FIG. 13 shows a state in which a blower according to an embodiment of the disclosure is being folded. FIG. 14 shows a state in which a blower according to an embodiment of the disclosure is folded.

Referring to FIGS. 13 and 14, at least a portion of the blower 30 may be provided to be flexible. At least a portion of the blower 30 may be provided to be foldable. The connection part 33 may be provided to be flexible. The connection part 33 may be provided to be foldable.

For example, the connection part 33 may be provided to be foldable with respect to a vertical center line V2 of the blower 30. For example, the blower 30 may be folded in half around the connection part 33. For example, as the connection part 33 is folded, the first blowing module 31 and the second blowing module 32 may be provided to face each other. For example, as the connection part 33 is folded, the first blowing module 31 and the second blowing module 32 may overlap each other. For example, as the connection part 33 is folded, the front surface 341 of the first blowing module 31 and the front surface 342 of the second blowing module 32 may face each other. For example, as the connection part 33 is folded, the rear surface 351 of the first blowing module 31 and the rear surface 352 of the second blowing module 32 may be provided to face in opposite directions.

As the connection part 33 is folded, the third coupling part 200a and the fourth coupling part 200b may face each other. As the connection part 33 is folded, the third coupling part 200a and the fourth coupling part 200b may be provided to correspond to each other.

In a state in which the connection part 33 is folded, the third coupling part 200a and the fourth coupling part 200b may be coupled to each other.

For example, the third coupling part 200a may include the third magnet, and the fourth coupling part 200b may include the fourth magnet in attraction with the third magnet. As an attractive force acts between the third coupling part 200a and the fourth coupling part 200b, a user may easily couple the third coupling part 200a and the fourth coupling part 200b without applying great force.

In a state in which the connection part 33 is folded, the third coupling part 200a and the fourth coupling part 200b may be coupled. The blower 30 may maintain a folded state as the third coupling part 200a and the fourth coupling part 200b are coupled.

The blower 30 may be stored in the folded state. The blower 30 may be stored separately from the mask body 10. The blower 30 may be stored separately from the second filter 50. Thus, storage of the blower 30 may be facilitated.

For example, referring to FIG. 14, the blower 30 may be stored in the folded state, whereby the space occupied by the blower 30 may be reduced. Portability of the blower 30 may be improved in the folded state. An inner portion of the blower 30 may not be easily contaminated in the folded state. For example, with the blower 30 folded, the first filter 40 may not be exposed to external foreign substances or the like.

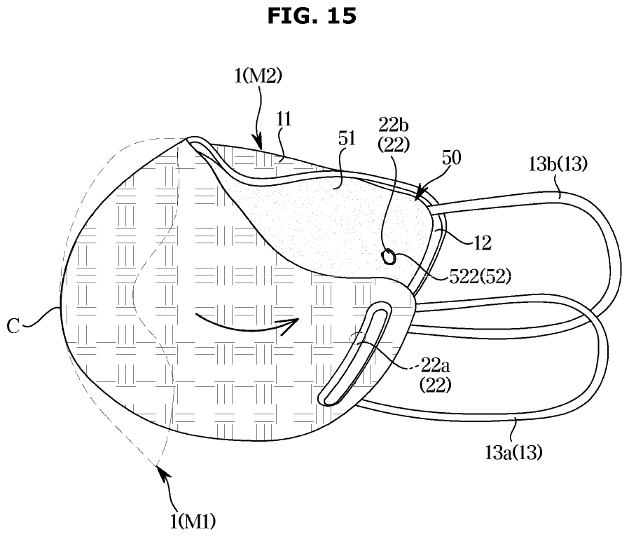

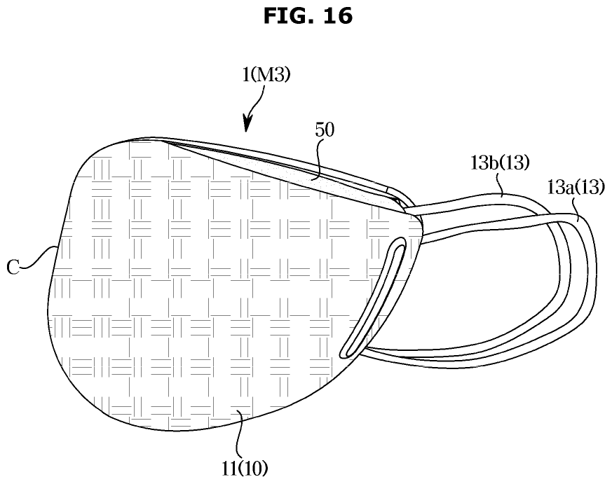

FIG. 15 shows a state in which a mask according to an embodiment of the disclosure is being folded. FIG. 16 shows a state in which a mask according to an embodiment of the disclosure is folded.

The mask 1 may include the mask body 10, the second filter 50, and the blower 30 disposed between the mask body 10 and the second filter 50.

At least a portion of the mask 1 may be provided to be flexible. At least a portion of the mask 1 may be provided to be foldable.

For example, the mask 1 may be provided to be foldable with respect to a vertical center line of the mask 1. For example, the mask 1 may be provided to be foldable with respect to the vertical center line V1 of the mask body 10. For example, the mask 1 may be provided to be foldable with respect to the vertical center line V2 of the blower 30. For example, the mask 1 may be provided to be foldable with respect to a vertical center line of the second filter 50. For example, the mask 1 may be provided to be foldable based on a central portion C of the mask 1. For example, the mask body 10, the blower 30, and the second filter 50 may be provided to be foldable together. For example, the mask 1 may be folded in a state in which the mask body 10, the blower 30, and the second filter 50 are coupled. For example, the mask 1 may be folded in half in a state in which the mask body 10, the blower 30 and the second filter 50 are assembled.

As the mask 1 is folded, the first holder part 20a and the second holder part 20b may face each other. In the state M2 in which the mask 1 is being folded, the first holder part 20a and the second holder part 20b may be provided to correspond to each other.

When the mask 1 is folded, the first holder part 20a and the second holder part 20b may be coupled to each other. In a state in which the mask body 10, the blower 30, and the second filter 50 are folded together, the first holder part 20a and the second holder part 20b may be coupled to each other. As described above, for example, in a state in which the mask 1 is folded, the first filter coupling portion 22a of the first holder part 20a and the second filter coupling portion 22a of the second holder part 20b may be coupled. The first holder part 20a and the second holder part 20b may be coupled in various ways.

As the first holder part 20a and the second holder part 20b are coupled, the mask 1 may maintain the folded state M3.

The mask 1 may be stored in the folded state M3. The mask body 10, the blower 30 and the second filter 50 may be stored together. The mask body 10, the blower 30, and the second filter 50 may be easily stored in an assembled state. Thus, storage of the mask 1 may be facilitated.

For example, referring to FIG. 16, the mask 1 may be stored in the folded state, whereby the space occupied by the mask 1 may be reduced. The mask in the folded state M3 can be stored in a smaller volume compared to the mask in an unfolded state M1. Portability of the mask 1 can be improved in the folded state M3. For example, while a user is not wearing the mask 1, such as eating or sleeping, the mask 1 can be easily stored. In addition, when storing the mask 1, it is not necessary to disassemble the mask 1. For example, since the entire mask 1 can be folded and stored, there is no need to separate the mask body 10 and the blower 30. Since the entire mask 1 can be folded and stored, there is no need to separate the mask body 10 and the second filter 50. Since the entire mask 1 can be folded and stored, there is no need to separate the blower 30 and the second filter 50. Also, when the mask 1 is stored, contamination of the filter 40 and/or 50 can be prevented. In the state M3 in which the mask 1 is folded, the filter 40 and/or 50 may not be exposed to external foreign substances. Also, during storage of the mask 1, the blower 30 can be prevented from being separated from the mask body 10. During storage of the mask 1, the second filter 50 may be prevented from being separated from the mask body 10. As a result, since components of the mask 1 are not separated during storage of the mask 1, loss of the mask body 10, the blower 30, and/or the second filter 50 may be prevented.

The mask 1 may be provided to be switchable between the unfolded state M1 and the folded state M3. A user may wear the mask 1 in the unfolded state M1. When the user is not wearing the mask 1, the mask 1 may be stored in the folded state M3.

For example, when the mask 1 is in the unfolded state M1, the mask body 10, the blower 30, and the second filter 50 may be in an assembled state. For example, when the mask 1 is in the unfolded state M1, the first coupling part 100a and the third coupling part 200a may be in a coupled state, and the second coupling part 100b and the fourth coupling part 200b may be in a coupled state. For example, when the mask 1 is in the unfolded state M1, the second filter 50 may be in a state in which the holder 20 is mounted.

For example, when the mask 1 is in the folded state M3, the first holder part 20a and the second holder part 20b may be in a coupled state as the mask body 10, the blower 30, and the second filter 50 are folded together in the unfolded state M1.

Although a few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A mask comprising:
a mask body including:
a first coupling part, and
a second coupling part spaced apart from the first coupling part; and
a blower including:
a third coupling part configured to be detachably couplable to the first coupling part and prevented from being coupled to the second coupling part, and
a fourth coupling part configured to be detachably couplable to the second coupling part and prevented from being coupled to the first coupling part,
so that, with the third coupling part detachably coupled to the first coupling part and the fourth coupling part detachably coupled to the second coupling part, the blower is disposed to a rear of the mask body and is operable to force air to flow into and out of the mask.

2. The mask of claim 1, wherein
the first coupling part includes a first magnet,
the second coupling part includes a second magnet,
the third coupling part includes a third magnet having magnetic attraction with the first magnet and magnetic repulsion with the second magnet, and
the fourth coupling part includes a fourth magnet having magnetic attraction with the second magnet and magnetic repulsion with the first magnet.

3. The mask of claim 1, wherein
the first coupling part includes a first guide that, with the blower disposed to the rear of the mask body, faces the blower,
the third coupling part includes a second guide that, with the blower disposed to the rear of the mask body, faces the first guide part, and
the second guide has a shape corresponding to the first guide to, with blower disposed to the rear of the mask body and the second guide facing the first guide, guide a coupling of the first coupling part and the third coupling part.

4. The mask of claim 1, wherein
the second coupling part includes a first guide that, with the blower disposed to the rear of the mask body, faces the blower,
the fourth coupling part includes a second guide that, with the blower disposed to the rear of the mask body, faces the first guide, and
the second guide has a shape corresponding to the first guide to, with the blower disposed to the rear of the mask body and the second guide facing the first guide, guide a coupling of the second coupling part and the fourth coupling part.

5. The mask of claim 1, wherein
the mask body is foldable, and
the first coupling part and the second coupling part are couplable in a state in which the mask body is folded.

6. The mask of claim 1, wherein the blower includes:
a suction module configured to suck air from outside of the mask body,
a discharge module configured to discharge air to outside of the mask body, and
a connection part configured to connect the suction module and the discharge module and to be foldable,
wherein as the connection part is folded, the suction module and the discharge module face each other.

7. The mask of claim 6, wherein
the suction module includes the third coupling part,
the discharge module includes the fourth coupling part, and
the third coupling part and the fourth coupling part are couplable in a state in which the connection part is folded

8. The mask of claim 1, further comprising:
a filter that, with the third coupling part detachably coupled to the first coupling part and the fourth coupling part detachably coupled to the second coupling part so that the blower is disposed to the rear of the mask body, is positionable at a rear of the blower and is configured to cover at least a portion of a user's face, and
wherein the mask body further includes a holder configured to hold the filter.

9. The mask of claim 8, wherein
the mask body, the blower and the filter are configured to be foldable together, and
the holder includes:
a first holder part, and
a second holder part spaced apart from the first holder part and couplable to the first holder part in a state in which the mask body, the blower, and the filter are folded together.

10. The mask of claim 8, wherein
the mask body is foldable, and
the holder includes:
a first holder part, and
a second holder part spaced apart from the first holder part and couplable to the first holder part in a state in which the mask body is folded.

11. The mask of claim 1, wherein
the blower further includes:
a fan configured to generate a blowing force, and
a switch configured to operate the fan,
the mask body further includes:
a button, and
with the third coupling part detachably coupled to the first coupling part and the fourth coupling part detachably coupled to the second coupling part so that the blower is disposed to the rear of the mask body,
the switch faces the mask body, and
the button is positioned to operate the switch.

12. The mask of claim 9, wherein
one of the first holder part and the second holder part includes a first magnet, and
the other one of the first holder part and the second holder part includes a second magnet that has magnetic attraction with the first magnet.

13. The mask of claim 9, wherein
one of the first holder part and the second holder part includes a magnet, and
the other one of the first holder part and the second holder part is configured to be magnetized by the magnet.

14. The mask of claim 9, wherein
one of the first holder part and the second holder part includes a coupling protrusion, and
the other one of the first holder part and the second holder part includes a coupling groove corresponding to the coupling protrusion.

15. The mask of claim 9, wherein
one of the first holder part and the second holder part includes a hook fastener, and
the other one of the first holder part and the second holder part includes a loop fastener.
